(19) United States
(12) Patent Application Publication
(10) Pub. No.: US 2023/0105037 A1
(43) Pub. Date: Apr. 6, 2023

(54) AUDIO SIGNAL PROCESSING METHOD AND AUDIO SIGNAL PROCESSING DEVICE

(71) Applicant: YAMAHA CORPORATION, Hamamatsu-shi (JP)

(72) Inventor: Akihiko SUYAMA, Hamamatsu-shi (JP)

(21) Appl. No.: 17/957,480

(22) Filed: Sep. 30, 2022

(30) Foreign Application Priority Data
Oct. 5, 2021 (JP) 2021-163852

(51) Int. Cl. G10L 21/0232; G10L 25/18; G10L 19/02

(52) U.S. Cl. CPC G10L 21/0232; G10L 25/18; G10L 19/02

(57) ABSTRACT

An audio signal processing method includes receiving an audio signal and an input target data, determining a predetermined reference input value, calculating a relative input value with respect to the predetermined reference input value, superimposing the audio signal with the predetermined reference input value on a first frequency domain of the audio signal and the relative input value on a second frequency domain, and sending the superimposed audio signal.

### CROSS-REFERENCE TO RELATED APPLICATIONS

This application is based on and claims priority under 35 USC 119 from Japanese Patent Application No. 2021-163852 filed on Oct. 5, 2021, the contents of which are incorporated herein by reference.

### TECHNICAL FIELD

An embodiment of the present invention relates to an audio signal processing method for superimposing data on an audio signal.

### BACKGROUND ART

Patent Literature 1 describes a configuration in which an illumination color and an illumination pattern are changed based on a frequency distribution state of an input audio signal. Patent Literature 2 discloses that an audio signal is upsampled and information is embedded, information is embedded in an inaudible region of 18 kHz by AM modulation, and the like.

### CITATION LIST

### Patent Literature

Patent Literature 1: JP2007-95472A

Patent Literature 2: WO2017/164156

### SUMMARY OF INVENTION

In the configuration of Patent Literature 1, information is extracted according to a frequency distribution. Therefore, in the configuration of Patent Literature 1, when a signal level changes due to volume adjustment or various factors of a transmission path such as a speaker, and a frequency characteristic is disrupted, the information is corrupted.

Also in a configuration of Patent Literature 2, when the AM modulation is executed, the information may be corrupted when a signal level changes. When the audio signal is upsampled, the audio signal may not be reproduced as it is.

Neither document assumes that an audio signal is digitally compressed (for example, conversion to MP3 or the like). In both the configurations disclosed in the related-art documents, information is corrupted when digital compression is executed.

Therefore, an object of an embodiment of the present invention is to provide an audio signal processing method capable of superimposing information on an audio signal without being affected by various factors of a transmission path.

An audio signal processing method according to an embodiment of the present invention includes receiving an audio signal and an input target data; determining a predetermined reference input value of the input target data; calculating a relative input value with respect to the predetermined reference input value; superimposing the audio signal with the predetermined reference input value on a first frequency domain of the audio signal and the relative input value on a second frequency domain of the audio signal; and sending the superimposed audio signal.

According to the embodiment of the present invention, information can be superimposed on an audio signal without being affected by various factors of a transmission path.

### BRIEF DESCRIPTION OF DRAWINGS

FIG. 1 is a block diagram showing a configuration of an audio signal processing system 1;

FIG. 2 is a block diagram showing a main configuration of an audio signal processing device 11;

FIG. 3 is a functional block diagram showing a minimum configuration of the present invention;

FIG. 4 is a flowchart showing an operation of superimposing an illumination signal in an audio signal processing unit 154;

FIG. 5 is a conceptual diagram showing an envelope of a time axis component of a reference input value and a frequency axis component of the reference input value;

FIG. 6 is a comparison diagram between a case where the reference input value changes smoothly between a maximum value and a minimum value over a predetermined time and a case where the reference input value changes between the maximum value and the minimum value in a stepwise manner;

FIG. 7 is a conceptual diagram showing a frequency axis component of an audio signal in which the reference input value and relative input values of RGB are superimposed;

FIG. 8 is a conceptual diagram showing a frequency axis component of an audio signal in which the reference input value and the relative input values of RGB are superimposed;

FIG. 9 is a conceptual diagram showing a frequency axis component of an audio signal in which the reference input value and the relative input values of RGB are superimposed;

FIG. 10 is a flowchart showing an operation of the audio signal processing device 11 at the time of reproduction;

FIG. 11 is a diagram showing a change timing of the relative input values of RGB and a reading timing of the relative input values; and

FIG. 12 is a diagram showing the number of samples.

### DESCRIPTION OF EMBODIMENTS

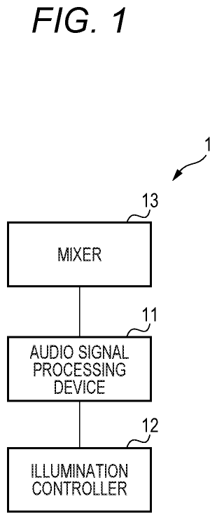

FIG. 1 is a block diagram showing a configuration of an audio signal processing system 1. The audio signal processing system 1 includes an audio signal processing device 11, an illumination controller 12, and a mixer 13.

The audio signal processing device 11 is, for example, an information processing device such as a personal computer. The audio signal processing device 11, the illumination controller 12, and the mixer 13 are connected according to a communication standard such as a USB cable, HDMI (registered trademark), Ethernet (registered trademark), or MIDI. The illumination controller 12 and the mixer 13 are installed in, for example, a venue where an event such as a live performance is held.

The mixer 13 connects a plurality of acoustic devices such as a microphone, a musical instrument, or an amplifier. The mixer 13 receives digital or analog audio signals from the plurality of acoustic devices. When the mixer 13 receives an analog audio signal, the mixer 13 converts the analog audio signal into, for example, a digital audio signal having a sampling frequency of 48 kHz. The mixer 13 mixes a plurality of audio signals. The mixer 13 transmits a digital audio signal after signal processing to the audio signal processing device 11.

The illumination controller 12 controls various illuminations used for presentation of an event such as a live performance. The illumination controller 12 outputs an illumination signal for controlling the illumination. The illumination signal is, for example, data of DMX512 standard. The data of DMX512 standard includes color information indicating 8-bit luminance values of RGB. The illumination controller 12 controls the illumination by outputting the illumination signal to an illumination device. The illumination controller 12 transmits the illumination signal to the audio signal processing device 11.

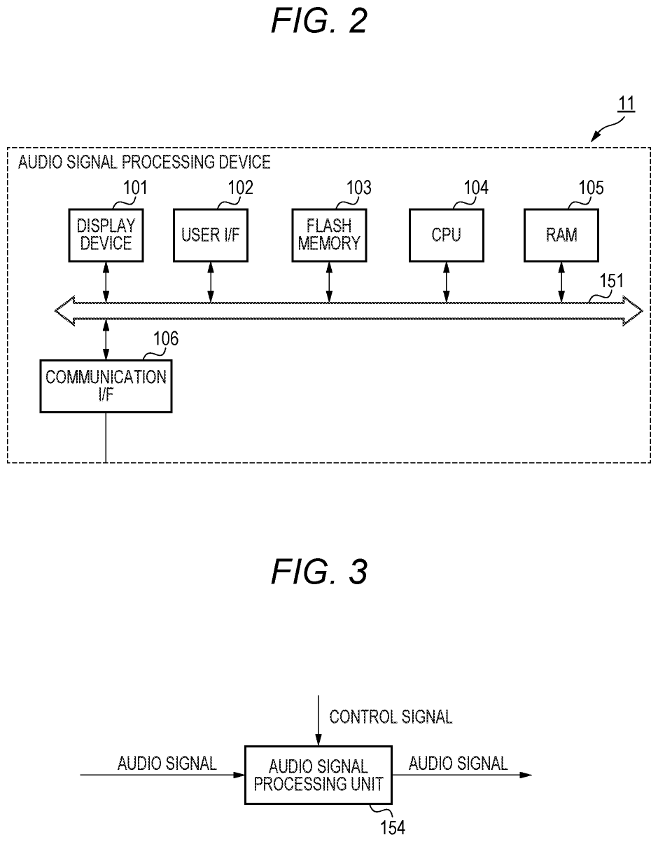

FIG. 2 is a block diagram showing a main configuration of the audio signal processing device 11. The audio signal processing device 11 is implemented by a general personal computer or the like, and includes a display device 101, a user interface (I/F) 102, a flash memory 103, a CPU 104, a RAM 105, and a communication interface (I/F) 106.

The display device 101 is implemented by, for example, a liquid crystal display (LCD), an organic light-emitting diode (OLED), or the like, and displays various information. The user I/F 102 is implemented by a switch, a keyboard, a mouse, a trackball, a touch panel, or the like, and receives a user operation. When the user I/F 102 is a touch panel, the user I/F 102 constitutes a graphical user interface (hereinafter abbreviated as GUI) together with the display device 101.

The communication I/F 106 is connected to the illumination controller 12 and the mixer 13 via a communication line such as a USB cable, HDMI (registered trademark), Ethernet (registered trademark), or MIDI. The communication I/F 106 receives a digital audio signal from the mixer 13. The communication I/F 106 receives an illumination signal from the illumination controller 12.

The CPU 104 reads a program stored in the flash memory 103, which is a storage medium, into the RAM 105 to implement a predetermined function. For example, the CPU 104 displays an image for receiving a user operation on the display device 101, and receives, via the user I/F 102, a selection operation or the like for the image, thereby implementing the GUI. The CPU 104 receives a digital audio signal from the mixer 13 via the communication I/F 106. In addition, the CPU 104 receives an illumination signal from the illumination controller 12 via the communication I/F 106.

The CPU 104 superimposes the illumination signal received from the illumination controller 12 on the audio signal received from the mixer 13. For example, the CPU 104 superimposes a sine wave component based on the illumination signal on an inaudible region (for example, 18 kHz) of the audio signal. The details will be described later.

The program read by the CPU 104 does not need to be stored in the flash memory 103 in a host device. For example, the program may be stored in a storage medium of an external device such as a server. In this case, the CPU 104 may read the program from the server into the RAM 105 each time and execute the program.

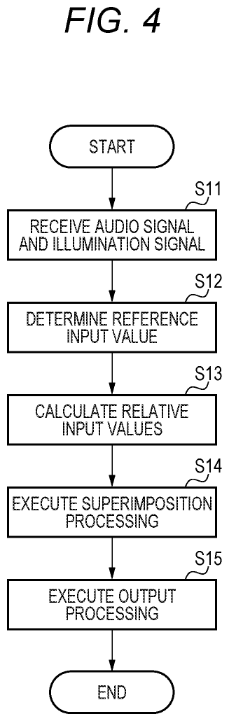

FIG. 3 is a functional block diagram showing a minimum configuration of the present invention. An audio signal processing unit 154 shown in FIG. 3 is implemented by the program executed by the CPU 104. FIG. 4 is a flowchart showing an operation of superimposing the illumination signal in the audio signal processing unit 154.

The audio signal processing unit 154 receives the audio signal and the illumination signal (S11). That is, as described above, the CPU 104 (the audio signal processing unit 154) receives the digital audio signal from the mixer 13 and receives the illumination signal from the illumination controller 12 via the communication I/F 106.

The audio signal processing unit 154 determines a reference input value (S12). The reference input value is a value as a reference for the illumination signal. As described above, the illumination signal includes the color information indicating the luminance values of RGB. The color information indicates the luminance value of each of R, G, and B with 8-bit information of, for example, 0 to 255.

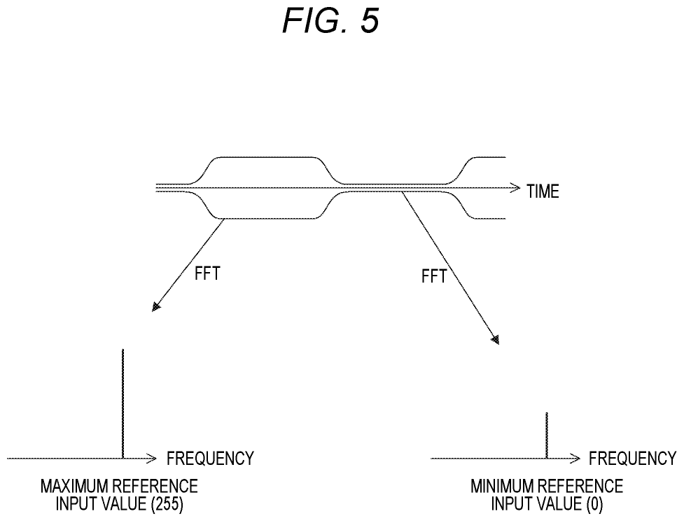

FIG. 5 is a conceptual diagram showing an envelope of a time axis component of the reference input value and a frequency axis component of the reference input value.

The reference input value is implemented by, for example, a sine wave audio signal. The reference input value periodically fluctuates between a level corresponding to a maximum value and a level corresponding to a minimum value on a time axis. A frequency does not change regardless of whether the reference input value is the maximum value or the minimum value. When fast Fourier transform (FFT) processing is executed on the audio signal of the reference input value, a level of a frequency component having 18 kHz as a center frequency as shown in FIG. 5 is shown. The reference input value periodically fluctuates between a level corresponding to a maximum value and a level corresponding to a minimum value on a frequency axis.

As shown in FIG. 5, it is preferable that the reference input value smoothly changes between the maximum value and the minimum value over a predetermined time. In an example of FIG. 5, the reference input value shows a level change in a curved shape (an S-shape) such that the level gradually changes from the maximum value (or the minimum value). Alternatively, the reference input value may change in a sine wave shape from the maximum value (or the minimum value) to the minimum value (or the maximum value) for the predetermined time. FIG. 6 is a comparison diagram between a case where the reference input value changes smoothly between the maximum value and the minimum value over the predetermined time and a case where the reference input value changes between the maximum value and the minimum value in a stepwise manner.

As shown in FIG. 6, when the level rapidly changes in a short time on the time axis, a large number of components different from the sine wave are included. Therefore, as shown by a frequency axis component on a right side of FIG. 6, a frequency characteristic of the reference input value spreads, and noise is generated. By smoothly changing the reference input value between the maximum value and the minimum value over the predetermined time, as shown by a frequency axis component on a left side of FIG. 6, it is possible to bring the reference input value closer to a sine wave component of a single frequency, to prevent the spread of the frequency characteristic, and to reduce the noise. The predetermined time is, for example, 10 msec to 15 msec. When it is desired to reduce an influence of the noise, the predetermined time is lengthened to make the reference input value closer to the sine wave. When it is desired to increase an amount of data to be transferred, the predetermined time may be shortened. The audio signal processing unit 154 determines the reference input value as described above (S12). Then, the audio signal processing unit 154 calculates a relative input value with respect to the reference input value from input target data to be superimposed. The input target data is the illumination signal, and includes the color information indicating the luminance values of RGB. For example, when the luminance value of R is 255, the audio signal processing unit 154 calculates a relative input value of R as the same level as the maximum value of the reference input value. For example, when the luminance value of R is 0, the relative input value of R is at the same level as the minimum value of the reference input value. For example, when the luminance value of R is 127, the relative input value of R is at a level of an intermediate value between the maximum value and the minimum value of the reference input value. For example, when an amplitude of the maximum value of the reference input value is 2.0 and an amplitude of the minimum value is 1.0, if the luminance value of R is 255, an amplitude of the relative input value of R is 2.0. When the luminance value of R is 0, the amplitude of the relative input value of R is 1.0. When the luminance value of R is 127, the amplitude of the relative input value of R is 1.5. That is, the audio signal processing unit 154 divides a range between the maximum value and the minimum value of the reference input value into 256 levels according to values of RGB, and calculates a relative input value of R, a relative input value of G, and a relative input value of B. Although a linear scale level is shown in this example, the audio signal processing unit 154 may proportionally calculate the relative input values using a log scale level.

The minimum value of the reference input value is preferably at a sufficiently high level so as to be distinguishable from background noise and at a sufficiently high level so as to be distinguishable from a high frequency component of the digital audio signal (an audio signal related to a content) from the mixer 13. The maximum value of the reference input value is preferably a value at which a level difference between the maximum value and the minimum value can be sufficiently obtained, for example, at a level at which no large load is applied to the speaker. As the difference between the minimum value and the maximum value increases, the audio signal processing unit 154 can increase the number of bits of data to be superimposed or improve accuracy with the same number of bits. The maximum value and the minimum value may be received from a user. Alternatively, the maximum value and the minimum value may be automatically determined according to a level of a high frequency component of a received audio signal.

Then, the audio signal processing unit 154 superimposes the reference input value and the calculated relative input values of RGB on the audio signal (S14). In the present embodiment, the audio signal processing unit 154 superimposes the reference input value of the illumination signal on a first frequency domain of the audio signal, and superimposes the relative input values of the illumination signal on a second frequency domain. The first frequency domain and the second frequency domain are preferably the inaudible regions such that information to be superimposed cannot be heard. The reference input value, the relative input value of R, the relative input value of G, and the relative input value of B are superimposed on different frequencies. The audio signal processing unit 154 preferably executes low-pass filter processing for removing a component of 18 kHz or more of the audio signal received from the mixer 13. Accordingly, a main component (a content audio) included in the audio signal received from the mixer 13 and superimposed components are not mixed.

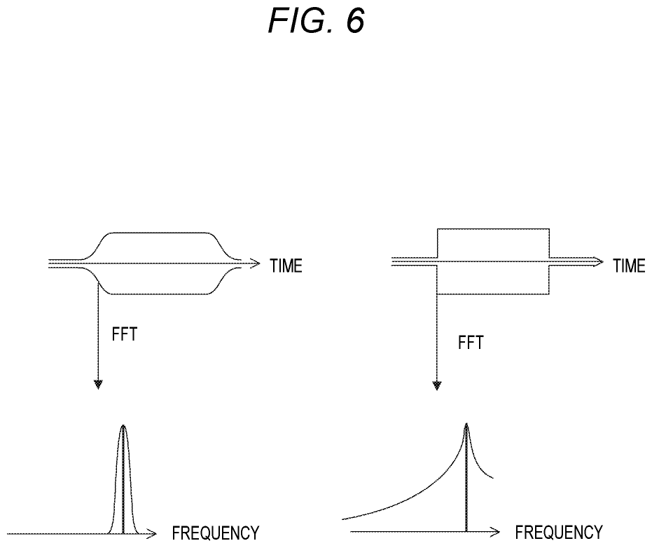

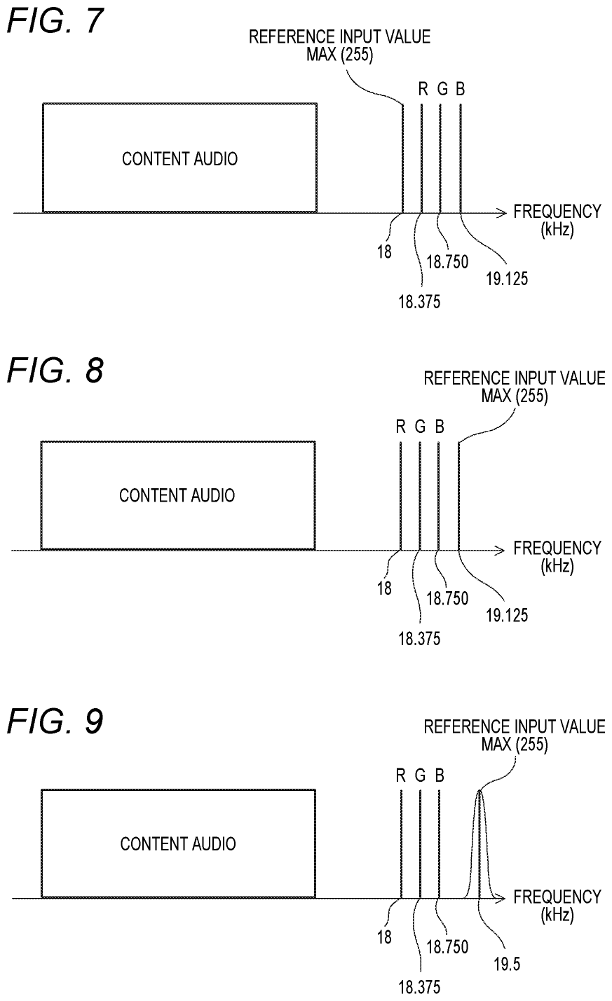

FIG. 7 is a conceptual diagram showing a frequency axis component of an audio signal in which the reference input value and the relative input values of RGB are superimposed. FIG. 7 shows an example in which white information is superimposed in which all values of RGB of the illumination signal are the maximum values. In this case, levels of the relative input values of RGB are all the same as a level of the maximum value of the reference input value.

For example, the audio signal processing unit 154 superimposes the reference input value on 18 kHz. For example, the audio signal processing unit 154 superimposes the relative input values of RGB on 18.375 kHz, 18.750 kHz, and 19.125 kHz, respectively. In this way, the reference input value, the relative input value of R, the relative input value of G, and the relative input value of B are superimposed on different frequencies. The reference input value, the relative input value of R, the relative input value of G, and the relative input value of B are preferably superimposed at intervals so as to reduce an interference between components. In this example, the audio signal processing unit 154 superimposes the reference input value, the relative input value of R, the relative input value of G, and the relative input value of B at intervals of 375 Hz.

A center frequency of each of the reference input value, the relative input value of R, the relative input value of G, and the relative input value of B preferably coincides with a frequency resolution of the audio signal. For example, when the number of samples on the time axis used for the FFT processing is 1024 samples and a sampling frequency of the audio signal is 48 kHz, a frequency resolution Fo is Fo=48000/1024=46.875 (Hz). When the frequency resolution Fo is multiplied by 8, an integer value of 46.875×8=375 is obtained. Therefore, the audio signal processing unit 154 superimposes the reference input value on 375×48=18000 Hz, superimposes the relative input value of R on 375×49=18375 Hz, superimposes the relative input value of G on 375×50=18750 Hz, and superimposes the relative input value of B on 375×51=19125 Hz. All of these frequencies coincide with the frequency resolution Fo. Therefore, when the FFT processing is executed on the audio signal on the time axis, a peak component of each of the reference input value, the relative input value of R, the relative input value of G, and the relative input value of B coincides with the frequency resolution, and is a peak component indicating a highest level.

As shown in FIG. 8, the audio signal processing unit 154 may superimpose the relative input value of R on 18 kHz, the relative input value of G on 18.375 kHz, the relative input value of B on 18.750 kHz, and the reference input value on 19.125 kHz. In this case, the reference input value is in a frequency domain farthest from an audible region. As described above, the reference input value periodically fluctuates between the level corresponding to the maximum value and the level corresponding to the minimum value on the time axis. Therefore, the reference input value has the spread of the frequency characteristic as shown in FIG. 6. Therefore, by superimposing the reference input value on a frequency far from the audible region, it is possible to further reduce the influence of the noise.

Further, as shown in FIG. 9, the audio signal processing unit 154 may superimpose the reference input value on a higher frequency (for example, 19.5 kHz). Accordingly, it is possible to further reduce an interference of a frequency component of the reference input value with the relative input values of RGB (B in FIG. 9). Also in a case where the reference input value is superimposed on a lower frequency side, the audio signal processing unit 154 may provide intervals between frequencies at which the reference input value and the relative input values are superimposed, respectively. For example, the reference input value is superimposed on 18 kHz, the relative input value of R is superimposed on 18.750 kHz, the relative input value of G is superimposed on 19.125 kHz, and the relative input value of B is superimposed on 19.5 kHz. In this case, it is possible to reduce an influence of a noise component due to the reference input value on the relative input values.

The audio signal processing unit 154 outputs the audio signal in which the reference input value and the calculated relative input values of RGB are superimposed as described above (S15). For example, the audio signal processing device 11 transmits the audio signal to a server (not shown) of an audio content distribution platform. Alternatively, the audio signal processing device 11 may record the audio signal in the flash memory 103 of the host device. The audio signal to be transmitted or the audio signal to be recorded may be subjected to compression processing such as MP3.

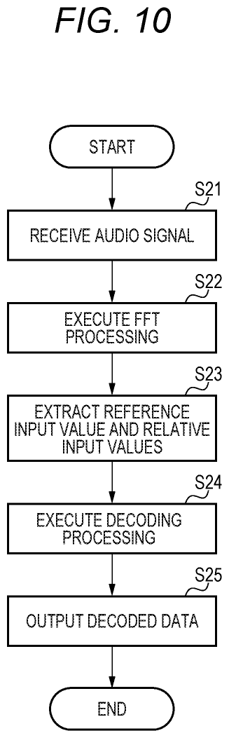

FIG. 10 is a flowchart showing an operation of the audio signal processing device 11 at the time of reproduction. The audio signal processing device 11 receives the audio signal via the server (S21). Alternatively, when the audio signal is recorded in the flash memory 103 of the host device, the audio signal processing device 11 reads the audio signal from the flash memory 103.

The audio signal processing device 11 executes the FFT processing on the received audio signal and converts the received audio signal into an audio signal having a frequency axis component (S22). Then, the audio signal processing device 11 extracts the reference input value and the relative input values (S23). That is, the audio signal processing device 11 extracts a component included in the first frequency domain of the audio signal as the reference input value, and extracts components included in the second frequency domain as the relative input values. The audio signal processing device 11 determines in advance what data is superimposed on which frequency domain and what data a signal of which frequency domain is extracted as. For example, in an example shown in FIG. 7, the audio signal processing device 11 extracts, as the reference input value, a component of a predetermined frequency domain (for example, a frequency width of 375 Hz) having a center frequency of 18 kHz. The audio signal processing device 11 extracts, as the relative input value of R, a component of a frequency domain having a center frequency of 18.375 kHz. The audio signal processing device 11 extracts, as the relative input value of G, a component of a frequency domain having a center frequency of 18.75 kHz. The audio signal processing device 11 extracts, as the relative input value of B, a component of a frequency domain having a center frequency of 19.125 kHz.

Then, the audio signal processing device 11 executes decoding processing (S24). The level of the relative input value indicates a value between the minimum value and the maximum value of the reference input value. Therefore, the audio signal processing device 11 first calculates a level of the minimum value and a level of the maximum value of the reference input value. For example, the audio signal processing device 11 measures a level of the component of the predetermined frequency domain having the center frequency of 18 kHz a plurality of times, and measures a level of a minimum value and a level of a maximum value. When the number of samples on the time axis used for the FFT processing is, for example, 1024 samples, the audio signal processing device 11 measures a level of a minimum value and a level of a maximum value using, for example, samples (5120 samples) for five times of FFT processing. The audio signal processing device 11 may confirm whether a difference between the level of the measured minimum value and the level of the measured maximum value is equal to or higher than a predetermined value. The audio signal processing device 11 may stop the decoding processing when the difference between the level of the minimum value and the level of the maximum value is less than the predetermined value. Accordingly, the audio signal processing device 11 can omit unnecessary processing.

The audio signal processing device 11 calculates a level of a relative input value of each of R, G, and B based on the level of the minimum value and the level of the maximum value of the reference input value, and converts the calculated levels into luminance values of RGB, respectively. The audio signal processing device 11 divides a range between the maximum value and the minimum value of the reference input value into 256 levels, and converts the levels of the relative input value of R, the relative input value of G, and the relative input value of B into the luminance values of R, G, and B, respectively. For example, when the level of the relative input value is the same as the level of the maximum value of the reference input value, the luminance value is 255. When the level of the relative input value is the same as the level of the minimum value of the reference input value, the luminance value is 0. When the level of the relative input value is at a level of an intermediate value between the maximum value and the minimum value of the reference input value, the luminance value is 127. In this way, the audio signal processing device 11 calculates the luminance values of RGB and decodes the illumination signal superimposed on the audio signal.

Then, the audio signal processing device 11 outputs decoded data (S25). For example, the illumination signal is output as data of DMX512 standard. The audio signal processing device 11 outputs the data of DMX512 to the illumination controller 12. The illumination controller 12 controls the illumination by outputting the illumination signal to the illumination device based on the DMX512. Alternatively, the audio signal processing device 11 may output the decoded data to another device such as a PC. The PC may control a display color and the like of the display device based on the received data.

The audio signal processing device 11 executes the operation shown in FIG. 10 and reproduces the received audio signal. The reproduced audio signal is output to the mixer 13 and emitted from the speaker in the live venue. At this time, the audio signal processing device 11 preferably reproduces the audio signal obtained after executing the low-pass filter processing to separate and remove the components of the first frequency domain and the second frequency domain of the audio signal. The audio signal processing device 11 may output the audio signal to another device such as a PC. The PC may reproduce the audio signal based on received data, and may control the display color and the like of the display device.

As described above, the audio signal processing device 11 can reproduce presentation of an event such as a live performance in a live venue by reproducing recorded data of a past live performance and outputting an illumination signal.

In the above embodiment, the audio signal processing device that superimposes the illumination signal and the audio signal processing device that decodes the illumination signal are the same device, but of course, may be different devices. The signal on which the illumination signal is superimposed is an audio signal, and thus may be transmitted and received not only through a data communication path such as a USB but also through a transmission path of an analog audio signal such as an audio cable. The illumination signal is superimposed on the audio signal as the relative input value with respect to the reference input value, and thus even if the audio signal is subjected to the compression processing, the reference input value and the relative input value are subjected to the same processing. Even when level change processing is executed on the audio signal, the level of the reference input value and the level of the relative input value also change in the same manner. Therefore, in the audio signal processing method according to the present embodiment, even when the level of the audio signal is changed or the compression processing is executed, it is possible to reliably transmit and receive superimposed data without being affected by various factors.

The signal on which the illumination signal is superimposed is the audio signal, and thus may also be transmitted and received via spatial transmission such as a speaker or a microphone. Also in this case, even when the level of the audio signal changes due to an influence of a spatial transmission characteristic, the level of the reference input value and the level of the relative input value also change in the same manner. Therefore, by the audio signal processing method according to the present embodiment, it is possible to reliably transmit and receive the superimposed data even when affected by the spatial transmission characteristic.

In particular, in the illumination signal shown in the present embodiment, even when a slight error occurs in the values of RGB, only a slight deviation occurs in a color of the illumination. The audio signal processing method according to the present embodiment is suitable for transmission and reception of such data which does not need to be decoded in a bit perfect manner.

### Modification 1

A timing at which the relative input values of RGB are changed may be any timing, and may be matched with, for example, a timing at which the reference input value changes from the minimum value to the maximum value. A timing at which the relative input values are extracted may be a timing at which the reference input value changes from the maximum value to the minimum value.

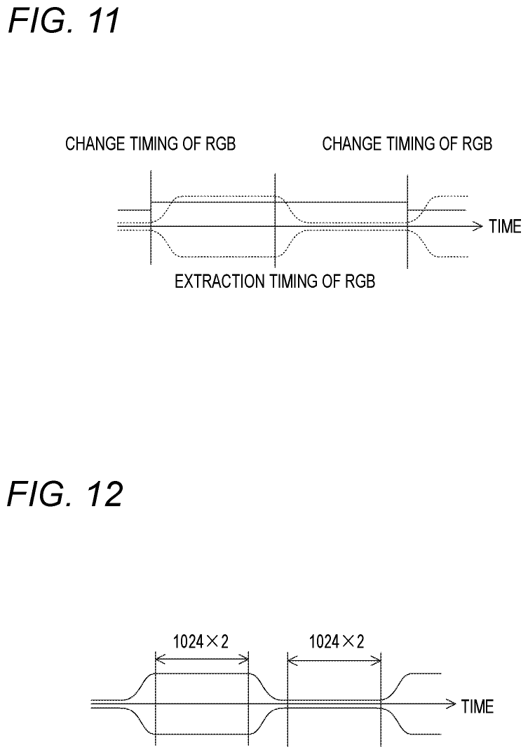

FIG. 11 is a diagram showing a change timing of the relative input values of RGB and a reading timing of the relative input values. In the drawing, a broken line indicates a time axis waveform of the reference input value, and a solid line indicates a time axis waveform of the relative input values.

Although the relative input values of RGB are also a sine wave, when the level rapidly changes in a short time on the time axis, a large number of components different from the sine wave are included, a frequency characteristic spreads, and noise is generated. Therefore, as shown in FIG. 11, the timing at which the relative input values of RGB are changed is matched with the timing at which the reference input value changes from the minimum value to the maximum value. The timing at which the relative input values are extracted is matched with the timing at which the reference input value changes from the maximum value to the minimum value. Accordingly, the relative input values of RGB do not change at the time of reading, and thus the audio signal processing device 11 can accurately calculate the level without being affected by the noise.

In an example of FIG. 11, the relative input values of RGB change in a stepwise manner, but the relative input values of RGB may also change smoothly over a predetermined time in the same manner as the reference input value. Accordingly, the audio signal processing device 11 can minimize an influence of the noise even when the values of RGB are changed.

### Modification 2

The number of samples of the reference input value is preferably twice or more as large as the number of samples required when the reference input value on the time axis is changed to the frequency component. FIG. 12 is a diagram showing the number of samples. For example, when the number of samples on the time axis used for the FFT processing is 1024 samples, the number of samples for maintaining the reference input value at the maximum value and the minimum value is at least 1024×2=2048 samples or more. If a change time in which the reference input value changes from the maximum value (the minimum value) to the minimum value (the maximum value) is half of 1024 samples, a total of the change times is 1024 samples. Therefore, the 2048 samples maintained at the maximum value, the 2048 samples maintained at the minimum value, and the 1024 samples of the change time total 5120 samples. Therefore, the audio signal processing device 11 can reliably acquire the maximum value and the minimum value by executing the FFT processing at least five times (1024×5=5120 samples).

### Modification 3

When an illumination signal cannot be extracted, the audio signal processing device 11 may maintain color information on an illumination signal extracted last time.

Alternatively, the audio signal processing device 11 may stop the output of the illumination signal when a state in which the illumination signal cannot be extracted continues for a predetermined time or more. The audio signal processing device 11 may use an average value of color information extracted a plurality of times up to the last time as current color information. In this case, the audio signal processing device 11 can also remove a sudden noise component.

### Modification 4

The level of the reference input value may be calculated based on a result of extracting a maximum value and a minimum value once, or may be calculated based on results of extracting maximum values and minimum values a predetermined number of times. For example, the audio signal processing device 11 regards an average value of the maximum values of the predetermined number of times as the level of the maximum value of the reference input value. The audio signal processing device 11 regards an average value of the minimum values of the predetermined number of times as the level of the minimum value of the reference input value. Alternatively, the audio signal processing device 11 may set a largest result as the maximum value and a smallest result as the minimum value among the results of the predetermined number of times. The audio signal processing device 11 may regard that a normal reference input value is extracted when a reference input value of a level equal to or higher than a predetermined value is extracted a predetermined number of times or more. Alternatively, the audio signal processing device 11 may regard that a normal reference input value is extracted when a difference between a maximum value and a minimum value of the reference input value is equal to or higher than a predetermined value.

As the predetermined number of times is smaller, the decoding processing can be executed in a shorter time, and as the predetermined number of times is larger, accuracy is improved.

### Modification 5

The reference input value may be superimposed not only on one frequency domain but also on a plurality of frequency domains. For example, the audio signal processing device 11 may superimpose a first reference input value on 19.125 kHz and superimpose a second reference input value on 19.5 kHz. In this way, the audio signal processing device 11 can also transmit and receive information in a plurality of channels by superimposing a plurality of reference input values. In this case, the first reference input value is a reference input value indicating levels of a maximum value and a minimum value. The second reference input value is a reference input value indicating information in a first channel or information in a second channel. For example, when the second reference input value indicates the maximum value, the audio signal processing device 11 regards the information in the first channel as being superimposed, and decodes luminance information in the first channel. When the second reference input value indicates the minimum value, the audio signal processing device 11 regards the information in the second channel as being superimposed, and decodes luminance information in the second channel. The audio signal processing device 11 may superimpose an even larger number of reference input values and transmit and receive information in an even larger number of channels. Alternatively, in a case of a stereo channel audio signal, the audio signal processing device 11 may superimpose the reference input value and the relative input value on an L channel and an R channel, respectively. In this case, the audio signal processing device 11 may superimpose L channel side information in the L channel and superimpose R channel side information in the R channel.

### Other Modifications

The audio signal processing device 11 may encode and decode certain data based on color information to be superimposed. For example, the audio signal processing device 11 superimposes color information in an order of black, black, and black, that is, color information of (0, 0, 0), (0, 0, 0), and (0, 0, 0) as data 00. When the color information of (0, 0, 0), (0, 0, 0), and (0, 0, 0) is decoded, the audio signal processing device 11 decodes the data 00. For example, the audio signal processing device 11 superimposes color information in an order of black, black, and red as data 01. When color information of (0, 0, 0), (0, 0, 0), and (255, 0, 0) is decoded, the audio signal processing device 11 decodes the data 01. For example, the audio signal processing device 11 superimposes color information in an order of black, black, and green as data 02. When color information of (0, 0, 0), (0, 0, 0), and (0, 255, 0) is decoded, the audio signal processing device 11 decodes the data 02.

The audio signal processing device 11 may superimpose information corresponding to a checksum. The checksum may be a value obtained by simply adding data (luminance values) of the above color information. The color information may be encoded and decoded not only with two values of 0 and 255, but also with three values of, for example, 0, 127, and 255, or may be encoded and decoded using an even larger number of pieces of color information. Further, checksums corresponding to the number of pieces of color information may be superimposed.

Information to be superimposed on the audio signal is not limited to the color information. For example, the information to be superimposed may be information related to brightness. For example, the information to be superimposed may be information related to a parameter such as an effect of the audio signal. In this case, the effect of the audio signal to be reproduced is automatically controlled. Alternatively, the information to be superimposed may be information for operating an operator of an electronic musical instrument. For example, the information to be superimposed may be position information on a pitch bend/modulation wheel of an electronic piano.

The information to be superimposed may be coordinate information in certain plane coordinates or spatial coordinates. For example, the information to be superimposed may be input information (input-on information, position information, and input-off information) on a pen tablet. In this case, the audio signal processing device 11 can draw a character or a picture in accordance with music by decoding the input information on the pen tablet in accordance with reproduction of the music. The information to be superimposed may be posture information on a robot. In this case, the audio signal processing device 11 can control a posture of the robot in accordance with the reproduction of the music. Accordingly, the audio signal processing device 11 can make the robot to dance in accordance with the music.

The information to be superimposed may be position information on an audio source. For example, in a content of an object-based system, audio signals of different channels are stored for respective audio sources. Therefore, the audio signal processing device 11 superimposes pieces of position information on the audio sources on the respective audio signals of the audio sources. The audio signal processing device 11 determines an audio image localization position of the audio source based on the decoded position information on the audio source, and executes localization processing.

The superimposition and the decoding of the information do not need to be executed in real time. For example, an illumination signal may be superimposed on an already recorded audio signal. In this case, the audio signal processing device 11 can superimpose the illumination signal or the like after analyzing the recorded audio signal. For example, the audio signal processing device 11 may calculate an average level of the recorded audio signal, and determine, based on the average level, a maximum value and a minimum value of the reference input value to be a level that is distinguishable from the audio signal (an audio signal related to a content). Alternatively, the audio signal processing device 11 may set, based on a level of a high frequency component of the audio signal (the audio signal related to the content) in a section to be superimposed, the maximum value and the minimum value of the reference input value to a sufficiently high level so as to be distinguishable from the high frequency component of the audio signal in the section to be superimposed.

It should be understood that the description of the present embodiment is to exemplify the present invention in every point and is not intended to restrict the present invention. The scope of the present invention is indicated not by the above embodiment but by the scope of the claims. Further, the scope of the present invention includes the scope equivalent to the scope of the claims.

For example, in the present embodiment, an example has been described in which the data of the relative input value is decoded based on the maximum value and the minimum value of the reference input value. However, for example, the audio signal processing device 11 may decode a bit 1 when a relative input value at a level higher than the level of the reference input value is extracted, and decode a bit 0 when a relative input value equal to or lower than the level of the reference input value is extracted, so as to decode superimposed data.

What is claimed is:

1. An audio signal processing method comprising:
receiving an audio signal and an input target data;
determining a predetermined reference input value of the input target data;
calculating a relative input value with respect to the predetermined reference input value;
superimposing the audio signal with:
the predetermined reference input value on a first frequency domain of the audio signal; and
the relative input value on a second frequency domain of the audio signal; and
outputting the superimposed audio signal.

2. The audio signal processing method according to claim 1, wherein
a level of the predetermined reference input value periodically fluctuates between a maximum value and a minimum value.

3. The audio signal processing method according to claim 2, wherein
the level of the predetermined reference input value changes between the maximum value and the minimum value over a predetermined time.

4. The audio signal processing method according to claim 1, wherein
the input target data includes color information.

5. The audio signal processing method according to claim 4, wherein
the input target data is an illumination signal.

6. The audio signal processing method according to claim 1, wherein
the first frequency domain and the second frequency domain are in inaudible regions.

7. The audio signal processing method according to claim 1, wherein
a center frequency of each of the first frequency domain and the second frequency domain coincides with a frequency resolution of the audio signal.

8. The audio signal processing method according to claim 1, further comprising:
separating components of the first frequency domain and the second frequency domain from the superimposed audio signal and reproducing the audio signal.

9. An audio signal processing device comprising:
a memory storing instructions; and
a processor that implements the instructions to
receive an audio signal and in input target data;
determine a predetermined reference input value of the input target data;
calculate a relative input value with respect to the predetermined reference input value from input target data;
superimpose the audio signal with:
the predetermined reference input value on a first frequency domain of the audio signal; and
the relative input value on a second frequency domain of the audio signal; and
output the superimposed audio signal.

10. The audio signal processing device according to claim 9, wherein
a level of the predetermined reference input value periodically fluctuates between a maximum value and a minimum value.

11. The audio signal processing device according to claim 10, wherein
the level of the predetermined reference input value changes between the maximum value and the minimum value over a predetermined time.

12. The audio signal processing device according to claim 9, wherein
the input target data includes color information.

13. The audio signal processing device according to claim 12, wherein
the input target data is an illumination signal.

14. The audio signal processing device according to claim 9, wherein
the first frequency domain and the second frequency domain are in inaudible regions.

15. The audio signal processing device according to claim 9, wherein
a center frequency of each of the first frequency domain and the second frequency domain coincides with a frequency resolution of the audio signal.

16. The audio signal processing device according to claim 9, wherein
the processor implements the instructions to separate components of the first frequency domain and the second frequency domain from the superimposed audio signal and reproduce the audio signal.

17. An audio signal processing method comprising:
receiving a superimposed audio signal containing an audio signal;
extracting a component included in a first frequency domain of the audio signal as a reference input value;
extracting a component included in a second frequency domain of the audio signal as a relative input value with respect to the reference input value;
decoding input target data from the superimposed audio signal based on the relative input value; and
outputting the decoded input target data.

18. An audio signal processing device comprising:
a memory storing instructions; and
a processor that implements the instructions to:
receive a superimposed audio signal containing an audio signal;
extract a first component included in a first frequency domain of the audio signal as a reference input value;
extract a second component included in a second frequency domain of the audio signal as a relative input value with respect to the reference input value;
decode input target data from the superimposed audio signal based on the relative input value; and
output the decoded input target data.
